(19) United States
(12) Patent Application Publication
(10) Pub. No.: US 2016/0267817 A1
(43) Pub. Date: Sep. 15, 2016

(54) Universal Jersey Number

(71) Applicant: Innov8 Partners, LLC, Modesto, CA (US)

(72) Inventor: Evan McKee, Woodside, CA (US)

(21) Appl. No.: 14/717,963

(22) Filed: May 20, 2015

Related U.S. Application Data
(60) Provisional application No. 62/000,816, filed on May 20, 2014.

(51) Int. Cl. G09F 3/02; A41D 1/04

(52) U.S. Cl. CPC G09F 3/02; A41D 1/04

(57) ABSTRACT

A sports jersey number device is convertible to display any of the digits 0 through 9, by opening or closing selected ones of seven flaps that display respective number segments.

### BACKGROUND OF THE INVENTION

This application claims benefit of provisional application No. 62/000,816, filed May 20, 2014.

The invention is concerned with sports jersey numbers, and more particularly is directed to a jersey number device, to be attached to a jersey of a particular background color, allowing adjustment of the device by securing and unsecuring selected ones of a series of flaps to produce any digit from 0 through 9.

In sports, particularly children's sports, each player on a team must have a unique jersey number, and this can cause problems in some situations. For example, a need can quickly arise for a numbered jersey for a particular player at the beginning of a season, such as if two players' jerseys bear the same number, or if a player does not have an appropriate jersey, etc. Also, a player might damage, lose or misplace a numbered jersey, requiring a quick replacement. This can cause unneeded difficulty and cost.

There is a need for a universal jersey number device that can be secured to a jersey of a particular background color, the device being adjustable to display any of the digits 0 through 9, and with two such devices side by side for double-digit numbers.

### SUMMARY OF THE INVENTION

The invention addresses this need, with a universal digit-forming device constructed of fabric or flexible sheet material, the device being securable to a jersey by stitching or adhesion or other techniques used for securing jersey numbers. The digit-forming device has a background color which will match the color for a particular team. Thus, the background color can be black, red, white, green, blue, etc., depending on the jersey to which it is to be secured. The device has a series of foldable/unfoldable flaps that cover or expose particular segments in a typical alpha-numeric segmented digit display, allowing adjustment of the device to display any of the digits 0 through 9. The segments each bear on one side the color to be displayed, e.g. white, while the series of individual flaps that cover particular segments are of the background jersey color, e.g. black, on the back side of these flaps. VELCRO, i.e. hook and loop fastener material, is on each of the flaps, as well as on each of two base receiving areas for each flap, to secure the display of the selected digit. The digit-displaying device can have two “windows”, preferably rectangular or square, in the usual positions of the alpha-numeric openings (at the two openings in an “8”), or these areas could be solid with the background color.

In this way, the invention allows a quick provision of any desired jersey number to be applied to a jersey of the background color, or it allows a change of jersey number whenever needed, such as if a jersey needs to be transferred to a different player. These and other objects, advantages and features of the invention will be apparent from the following description of a preferred embodiment, considered along with the accompanying drawings.

### DESCRIPTION OF THE DRAWINGS

FIG. 1 shows a jersey digit-forming device in a fully closed state, displaying no digit, and illustrating structure of the device.

FIGS. 2 through 11 show display on the device of digits 0 through 9, respectively.

FIG. 12 shows the device with a particular form of digit-forming flaps.

### DESCRIPTION OF PREFERRED EMBODIMENTS

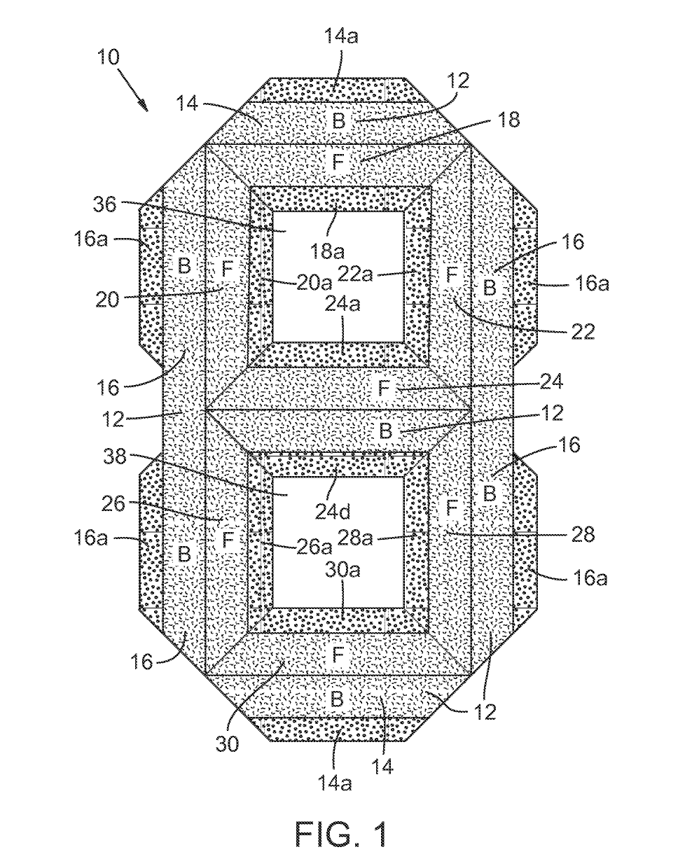

FIG. 1 shows a universal jersey number device 10 essentially in plan view, with no digit being displayed. The back side (not shown) of this device 10 is essentially flat (but flexible) and is to be engaged against the surface of a jersey, by stitching, adhesion or other means. In many cases two of the universal number devices 10 can be positioned side by side so as to be able to produce a double-digit number.

The device 10 has a base 12 that is essentially a flat sheet that may be in the shape shown, with upper and lower appendages 14 and two pairs of left and right appendages 16, although the outer pattern or configuration of the base sheet could be larger and could be square or oval, for example. Visible parts of the base in FIG. 1 are also designated B, while flaps are designated F. The configuration of the appendages 14 and 16 is essentially a minimum outline, the reason being that the device 10 includes seven movable flaps, all in the closed position here, and six of which when opened will be swung outwardly and engaged and held against those appendages 14 or 16. The base 12 with its appendages preferably follows the shape of the flaps when opened, but the base could be of a larger area if desired.

In FIG. 1 the movable flaps are shown at 18, 20, 22, 24, 26, 28 and 30. The flap 18 is at top, the flaps 20 and 22 are left and right upper flaps, the flap 24 is a center flap, the flaps 26 and 28 are left and right lower flaps, and the flap 30 is a bottom flap. Each of these flaps 18-30 bears a strip of VELCRO hook/loop fastener material, to be engaged with a mating VELCRO strip 14a on each of the top and bottom appendages 14 or a VELCRO strip 16a on one of the left and right appendages 16, thereby to retain the movable flap fully opened, as discussed below. The VELCRO strips of each flap 18-30 are designated 18a, 20a, 22a, etc. In the case of the center movable flap 24, when it is open its VELCRO strip 24a will engage with a VELCRO strip at 24d that is mounted on or fixed relative to the base sheet 12.

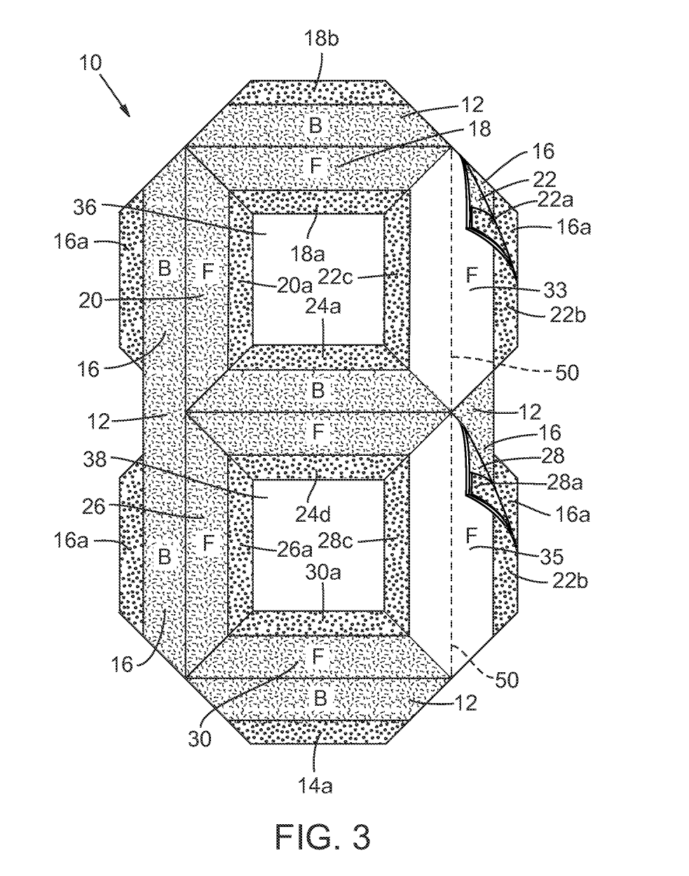

FIG. 3 shows the digit-forming device 10 with the upper and lower right side flaps 22 and 28 partially opened, an adjustment which when completed will display the digit “1”. In this example the insides of the flaps, along with an adjacent area secured to the base sheet 12, in the areas 32a, 32b, 34a and 34b as shown on the drawing, display the digit segments, white in this example. When closed, as in FIG. 1, the flaps fold over these white segment areas and hide them from view; when opened, they expose the white segments that make the “1”. FIG. 3 shows an inner or “closing” hook/loop fastener strip 22b on the flap 22 just opposite (behind) the outer VELCRO strip 22a that was visible in FIG. 1. This fastener strip 22b engages with a fixed fastener strip 22c (visible in FIG. 3) that is secured to the base sheet 12. For example, the outer and inner, back-to-back VELCRO strips 22a and 22b of the flap 22 can be hook fastener strips, while the fixed (base-secured) VELCRO strips 16a and 22c, to which the flap 22 is alternatively connected, can be loop fastener material. It should be understood that when the digit “1” is fully revealed, the outer edges of the right flaps 22 and 26 will be anchored down to the right appendages 16 of the base sheet, exposing the two adjacent white segments 33 and 35. All other white segments, which will make up parts of various other digits, are covered and not visible, as shown in FIG. 3, and only the base color, which is the color of the jersey itself, is seen around the displayed digit.

The digit-forming device 10 includes upper and lower “windows” 36 and 38 as seen in FIGS. 1-3. These are surrounded by VELCRO strips, which could be either the hook or loop fasteners, but preferably are the loop fasteners in this preferred embodiment. As noted above, these windows need not be provided, but instead the base sheet could be solid through these areas if desired, the color being the base sheet color, same as the jersey to which the number is to be applied.

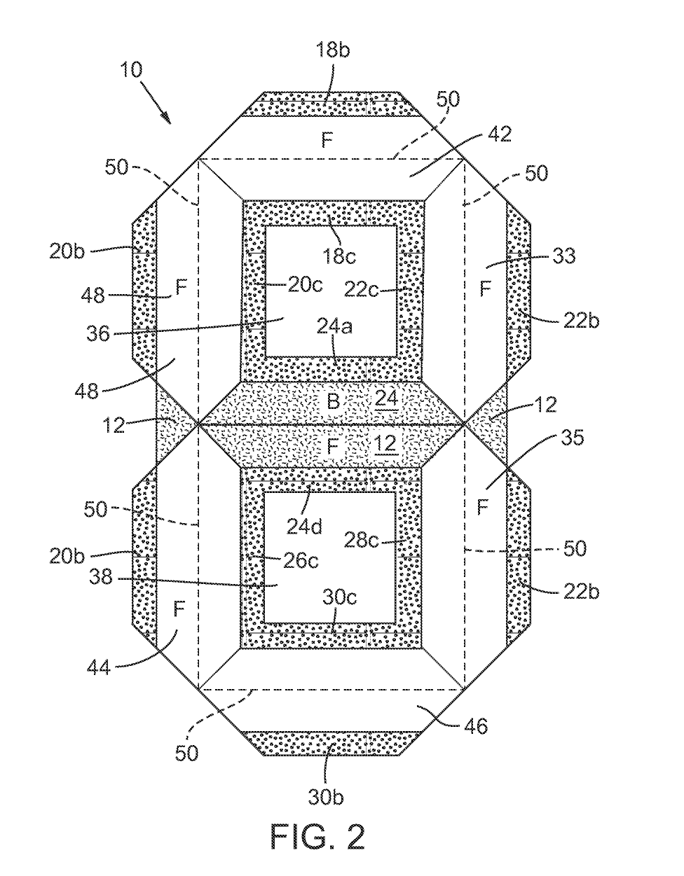

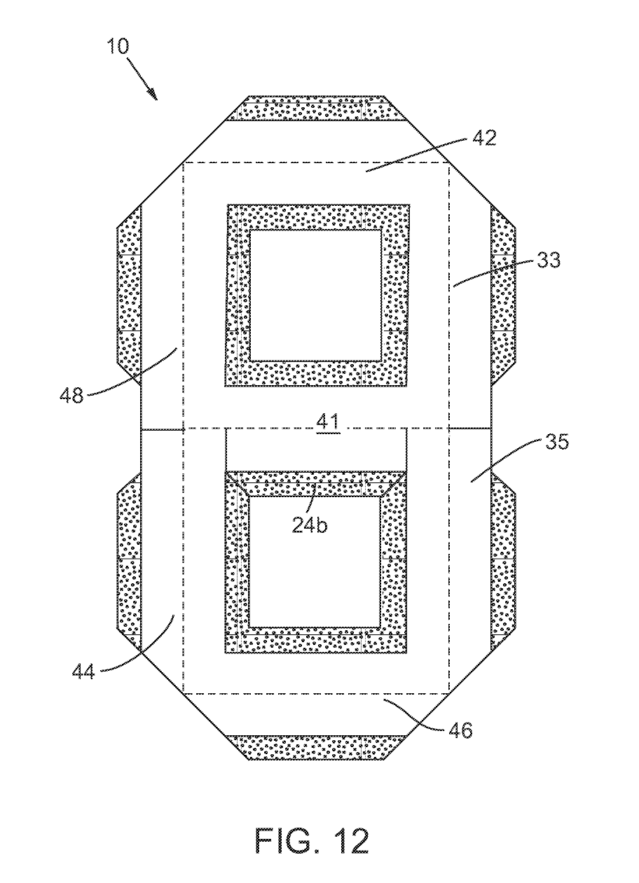

FIG. 2 shows formation of the zero. Note that FIGS. 1 and 2 show a preferred shape of the flaps, terminating as points or arrows, especially the vertical segments 33, 48, 35 and 44 where they meet at mid-height, and also the center flap 24. Squared ends are shown for these segments in FIG. 12, as discussed below.

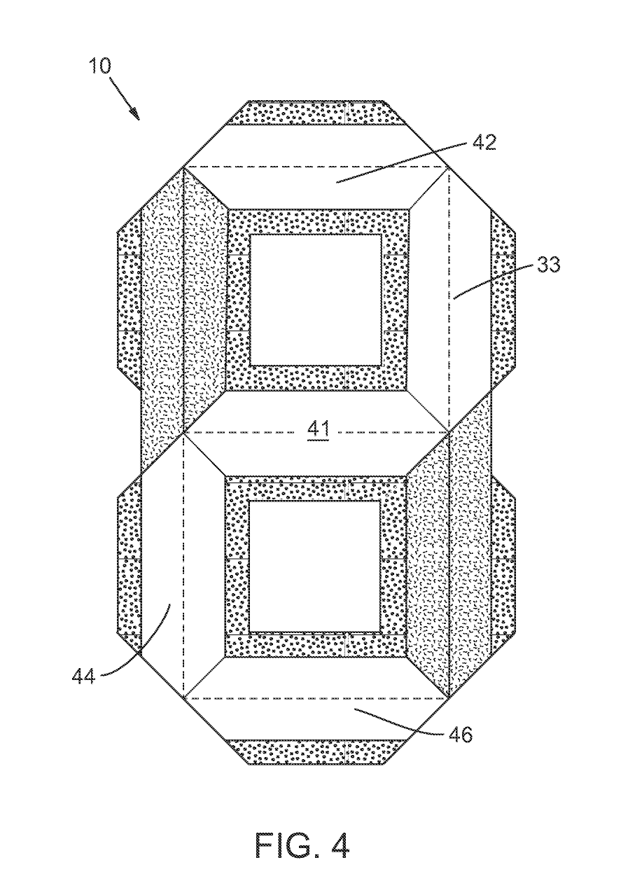

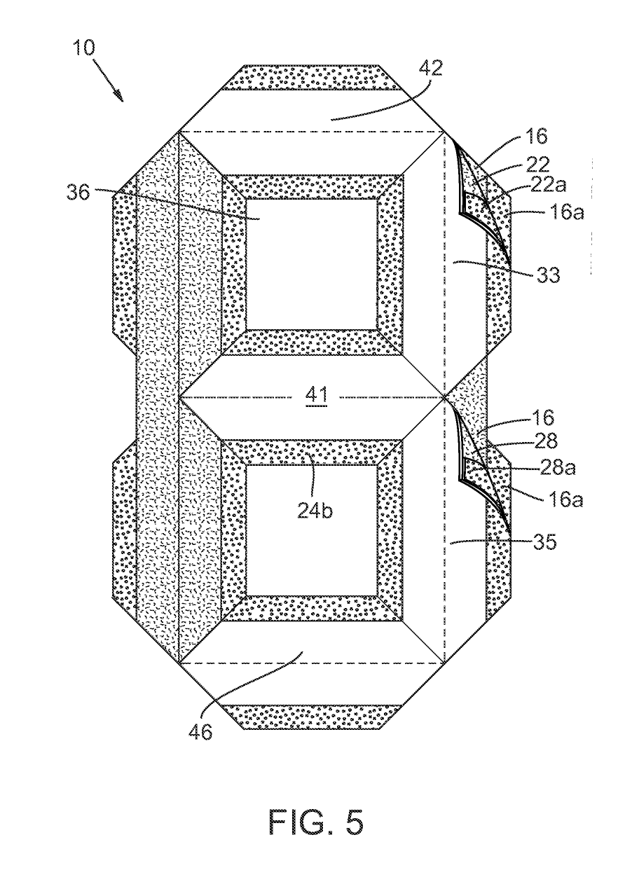

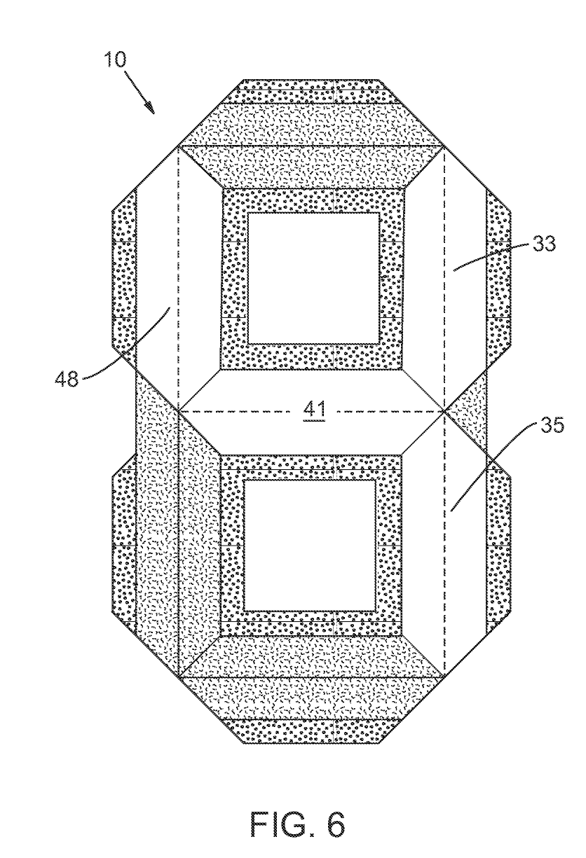

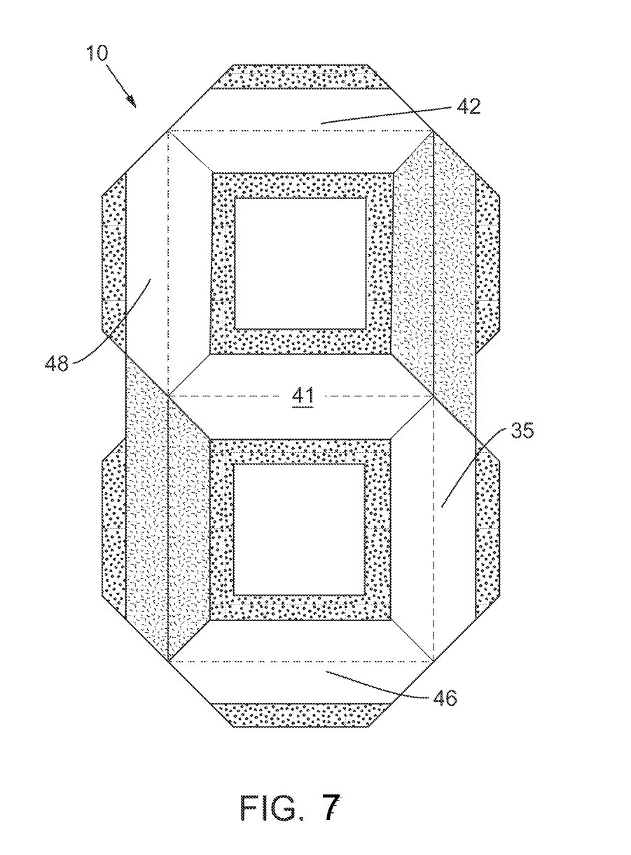

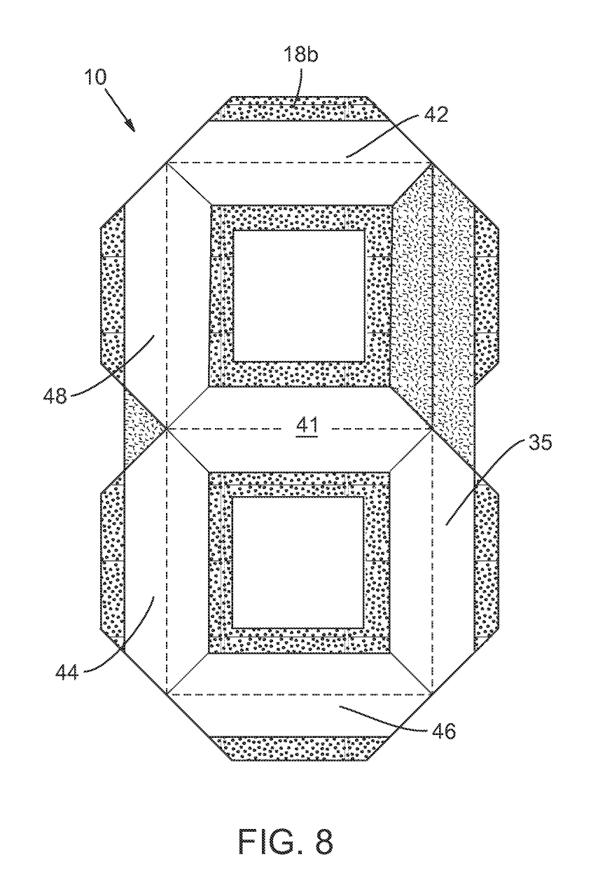

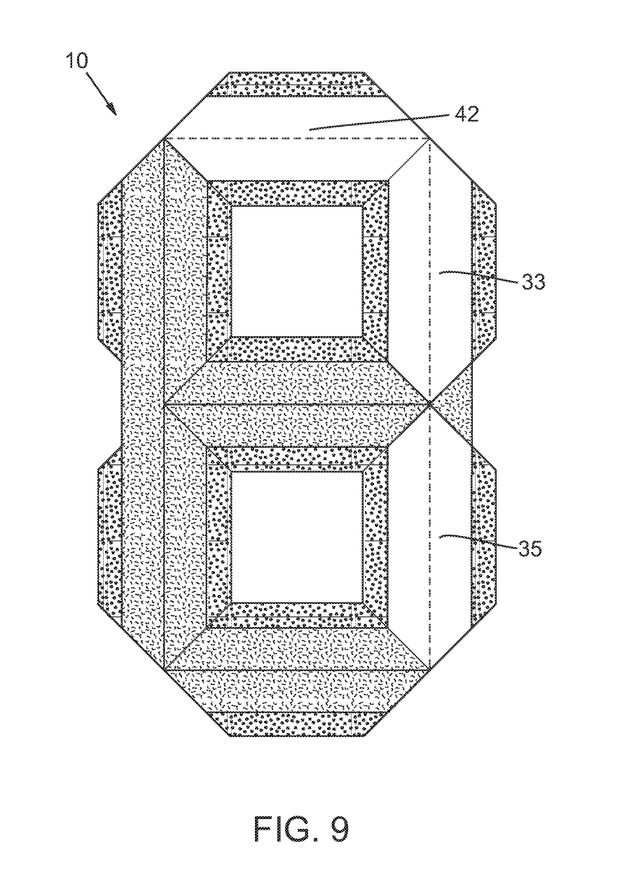

FIG. 4 shows the formation of the digit “2”. As compared to FIG. 3, showing the digit “1”, the center flap 24 has been opened (folded downwardly in this embodiment) to expose a white segment 41, the lower right flap 28 has been closed to cover that white segment 35, the top flap 18 has been opened to expose a top segment 42, the lower left flap 26 has been opened to expose a lower left white segment 44, and the bottom flap 30 has been opened to expose a bottom white segment 46. In each case the opened or closed flaps are held in the desired position by the hook and loop fastener material. On the center flap 24 the white-side VELCRO strip 24b is more visible, its opposite-side VELCRO strip 24a now holding the flap 24 open.

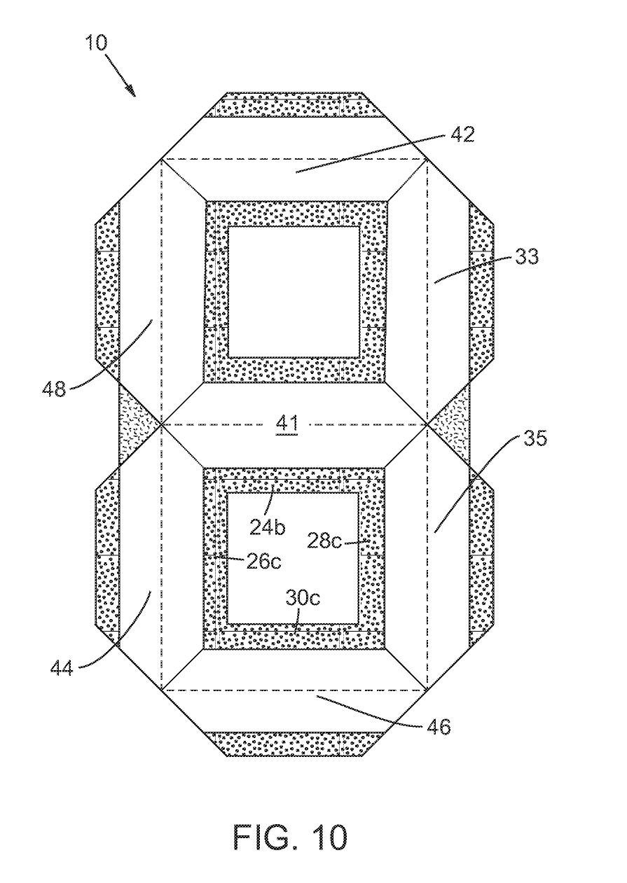

FIG. 10 (as well as FIG. 12) shows the digit “8”, revealing all of the flaps fully opened. All of the segments previously discussed, 41, 42, 33, 35, 44 and 46, as well as the upper left segment 48, are revealed to make the “8”. All fold lines are seen (these being indicated as dashed lines 50 in FIG. 12). The base is not visible (the flaps overlie it), except at the base-secured VELCRO strips 18c, 20c, 22c, 24c, 26c, 28c and 30c, these being numbered to indicate the corresponding flaps which they are capable of holding closed.

The shape of the flaps 18-30, and the shapes of the digit-forming segments that follow, are an important feature of the invention. Each foldable flap preferably is trapezoid-shaped, preferably with 45°-angled edges, so that when opened the flaps will form segment ends as shown in the drawings, and when closed, each flap is permitted to be closed without interference from a neighboring flap. Thus, if the top flap 18, for example, were to be closed, its left edge would not interfere with the upper edge of the upper left flap 20. Alternatively, the center flap could have a rectangular white area and the left and right flaps, where the uppers and lowers meet half way up, could have rectangular ends, as shown in FIG. 12. This provides continuous white vertical lines for digits such as “0”, “1”, “4”, “6”, “7”, “8” and “9”, but introduces square “steps” in digits such as “2”, “4” and “6”, as can be envisioned from FIG. 12.

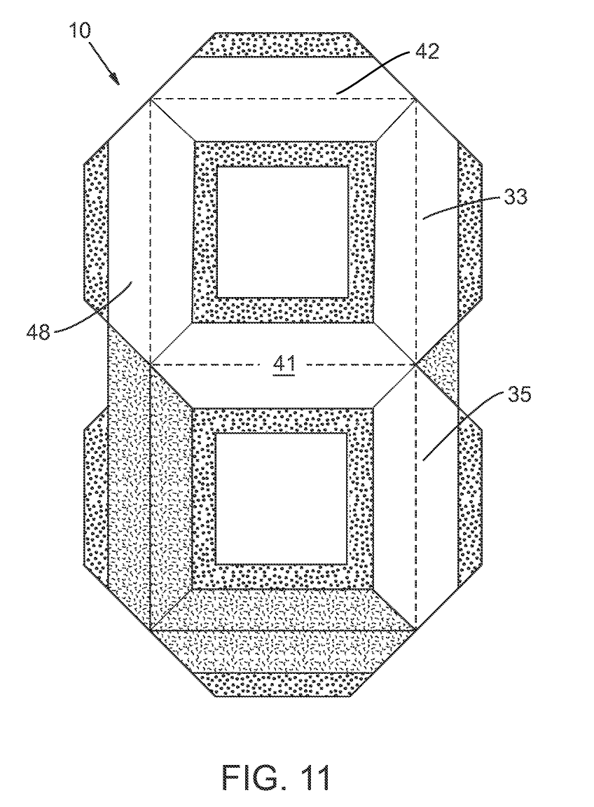

As can be seen from FIGS. 4 and 10, the digit “2” can be made into the digit “8” simply by opening the upper left flap 20 and the lower right flap 28. Similarly, the “8” can be made into a “0” (FIG. 2) simply by closing the center flap 24, hiding that white segment. The “8” can be made into a “9” simply by closing the lower left flap 26 and the bottom flap 30, as shown in FIG. 11.

The remaining digits, 3, 4, 5, 6 and 7 can be formed as shown in the drawings.

Although VELCRO is preferred for the device as described above, other forms of retention can be used, such as snaps or releasable/reusable adhesives, or a weak liquid bond or even static or magnetic attraction (small magnets held in or on fabric). Note also that while the display segments herein are described as white, they could be black or another color contrasting with the jersey in the event that the jersey, and thus the base areas of the digit-forming device, is white or another color.

The above described preferred embodiments are intended to illustrate the principles of the invention, but not to limit its scope. Other embodiments and variations to these preferred embodiments will be apparent to those skilled in the art and may be made without departing from the spirit and scope of the invention.

I claim:

1. A universal jersey number device to display any of digits 0 through 9 when secured on a sports jersey, comprising:
a base layer suitable for attaching exteriorally to a jersey, with a background color that can be matched to that of a jersey,
a series of seven digit-forming segments positioned on the base layer in a generally figure-eight array such that exposure of selected segments with remaining segments hidden will produce and display any selected digits of the digits 0 through 9, all segments being of a color and brightness contrasting with the background color of the base layer so that a selected digit is displayed prominently against the base layer,
each segment having a fold line by which a flap forming essentially one-half the segment can be folded over the other half of the segment, to a closed position of the segment so as to cover and hide the display of segment, the flap having a back side of essentially the same color and brightness as the background color so as to fully hide the segment when the flap is folded to the closed position, and
flap retention means for holding a segment flap in closed position when closed and for holding a segment flap in open position when opened,
whereby with all flaps in open position the digit 8 is displayed; with a flap of a central segment closed and the remaining segments open the digit 0 is displayed; with five segment flaps closed and two aligned vertical segments remaining open the digit 1 is displayed; and all other digits can be selected and displayed as desired.

2. The universal jersey number device of claim 1, wherein the flap retention means comprises hook and loop fasteners suitably positioned on the base layer and on an edge of each flap.

3. The universal jersey number device of claim 2, wherein each flap has an outer edge with a tab having hook fasteners on both sides of the tab.

4. The universal jersey number device of claim 1, wherein the base layer includes two openings at upper and lower positions corresponding to centers of upper and lower parts of a figure eight.

5. The universal jersey number device of claim 1, wherein the fold line extends in the lengthwise direction of each segment.
